(19) United States
(12) Patent Application Publication
(10) Pub. No.: US 2026/0317615 A1
(43) Pub. Date: Oct. 15, 2026

(54) GREEN SYNTHESIS OF MICROWAVE-ASSISTED CELLULOSE NANOCRYSTALS

(71) Applicant: SAUDI ARABIAN OIL COMPANY, Dhahran (SA)

(72) Inventors: Majd Salah Abdulaziz ALREFAIE, Dhahran (SA); Ameerah M. BOKHARI, Dhahran (SA)

(73) Assignee: SAUDI ARABIAN OIL COMPANY, Dhahran (SA)

(21) Appl. No.: 19/175,895

(22) Filed: Apr. 10, 2025

(51) Int. Cl. C09K 8/10; C08B 15/00

(52) U.S. Cl. CPC C09K 8/10; C08B 15/00

(57) ABSTRACT

The present disclosure relates to a method for producing cellulose nanocrystals (CNCs). The method comprises combining a weak organic acid, a Lewis acid, cellulose, and water to form an acidic cellulose solution. The acidic cellulose solution is then hydrolyzed at a temperature ranging from about 25° C. to about 140° C. or for a reaction time ranging from about 20 minutes to about 24 hours using a microwave energy source to create CNCs. The CNCs are subsequently separated from the remaining acidic cellulose solution and dried. Additionally, the disclosure includes a method of enhancing water-based drilling fluids by adding the produced CNCs to the fluid and introducing the enhanced fluid to a subterranean formation.

### FIELD OF THE DISCLOSURE

The present disclosure relates generally to synthesizing cellulose nanocrystals using microwaves as an energy source, and more specifically developing the cellulose nanocrystals via green synthesis to enhance the thermal stability of the water-based drilling fluids.

### BACKGROUND OF THE DISCLOSURE

In oil and gas well drilling, drilling fluids are one of the crucial parts for the success of drilling operations, the drilling fluid removes the cuttings from the hole, lubricates the drill bit, and maintains pressure control of the well as it is being drilled. The formulation of drilling fluids with different properties depends on the formations to be drilled due to different high pressure, high temperature (HPHT) conditions. It also has to be taken into consideration the required properties of drilling fluids as per API recommendation, including rheological, filtration, density, inhibition, and lubricant. In order to perform the functions smoothly, polymer-based additives are often added into drilling fluids to enhance their properties. Cellulose based products are one of the environmentally friendly drilling fluid additives that been used frequently in drilling and cementing operations. It is one of the most abundant renewable bio-polymer resources available on earth with an approximate annual production of about 7.9 million metric tons. Cellulose based products are obtained from wood, various agricultural waste remains, or plants including wheat, straw, soybean, cotton, sugarcane bagasse, flax, corn, coconut crops, pineapple, and bananas peels.

However, in an HPHT environment, these cellulose based products could be degraded or deteriorated due to inadequate thermal stability properties.

Accordingly, cellulose based products with improved thermal stability would be desirable for use in the oil and gas drilling operations. Further desirable would be a “green,” energy-efficient approach to forming a cellulose based products.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an aspect consistent with the present disclosure, the present disclosure relates to a method of producing cellulose nanocrystals (CNCs) comprising: combining a weak organic acid, a Lewis acid, and a cellulose, and water to form an acidic cellulose solution; hydrolyzing the acidic cellulose solution at a temperature from about 25° C. to about 140° C. or a reaction time from about 20 minutes to about 24 hours via a microwave energy source to create CNCs; separating the CNCs from the remaining acidic cellulose solution; and drying the CNCs.

In some aspects, the present disclosure relates to a method comprising: adding cellulose nanocrystals produced from claim 1 to a water-based drilling fluid to create an enhanced water-based drilling fluid; and introducing the enhanced water-based drilling fluid to a subterranean formation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 shows Fourier transform infrared spectroscopy of cellulose (solid line) and CNC (dashed line), as described in Example 2.

FIG. 2 shows X-ray diffraction information for cellulose (solid line) and CNC (dashed line), as described in Example 2.

FIG. 3 shows zeta potential measurements of cellulose (solid line) and CNC (dashed line), as described in Example 2.

FIG. 4 shows thermogravimetric curves of cellulose (solid line) and CNC (dashed line), as described in Example 2.

FIG. 5 shows differential scanning calorimetry curves of cellulose (solid line) and CNC (dashed line), as described in Example 2.

FIG. 6 shows a scanning electron microscopy (SEM) generated image for CNC, as described in Example 2.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Cellulose nanocrystals (CNCs) may be used in many oil and gas applications, especially in drilling completion, owing to their capacity for enduring high subsurface temperature conditions. Due to the reduction in their sizes and the removal of the amorphous regions in cellulose, CNCs have better crystallinity index than cellulose itself, and hence increased thermal stability. CNCs provide an environmentally friendly alternative to some hazardous and expensive chemicals or additives in drilling and cementing applications. The present disclosure further provides green, energy efficient approaches for synthesizing CNCs.

As part of the ongoing sustainability efforts in the oil and gas industry, the methods and compositions produced from the methods of this disclosure enhanced green synthesis of the drilling fluid additives. The synthesis of cellulose nanocrystals (CNCs) are utilized as additives for thermal stability enhancement in the water-based drilling fluids from biodegradable biomass via microwave-assisted aluminum chloride (AlCl₃) catalyzed formic acid hydrolysis.

Cellulose is an abundant organic polymer comprising superfine fibrils. The superfine fibrils primarily include two regions: highly ordered crystalline regions having nano-scale diameters and low-order amorphous regions. The term “cellulose nanocrystals” refers to the highly ordered crystalline region of the cellulose extracted from the amorphous region.

Sources of cellulose include, but are not limited to, plants such as wood, cotton, and hemp, among others; and bacteria, such as Komagataeibacter xylinus. Examples of plant-based cellulose include bleached eucalyptus pulp, bleached spruce wood pulp, corn cob fiber element, cotton paddle, micro-crystalline cellulose, bleached reed pulp, bleached wheat straw pulp, or any combination thereof.

Generally, the extraction of the CNCs typically occurs via inorganic acid hydrolysis. These inorganic acids include sulfuric acid, hydrochloric acid, phosphorous acid, with the sulfuric acid being the widely consumed one in such reaction due to its strong acidity in water (pKa=−10.0) They are highly effective in isolating the crystalline regions of cellulose and degrading the amorphous regions. However, such inorganic acids can harshly degrade the cellulose content, and they require additional or extensive washing and recovery process of the cellulose. In addition, inorganic acids are extremely corrosive to metals, preparation equipment, and exhibit non-biodegradable nature. In addition, the CNCs extracted from sulfuric acid hydrolysis exhibit negatively charged sulfate groups on their surfaces that reduce their thermal stability properties.

By contrast, embodiments in accordance with the present disclosure generally relate to synthesizing cellulose nanocrystals using microwaves as an energy source in conjunction with an organic acid and a Lewis acid to create cellulose nanocrystals that are suitable for use to enhance the thermal stability of the water-based drilling fluids.

Methods of producing cellulose nanocrystals may include adding a weak organic acid and a Lewis acid to a cellulose solution to form an acidic cellulose solution; hydrolyzing the acidic cellulose solution at a temperature of less than or equal to 140° C. or a reaction time from less than or equal to 24 hours (e.g., less than or equal to 10 hours, less than or equal to 90 minutes, or less than or equal to 45 minutes, e.g., 10 minutes or more, or 20 minutes or more) via a microwave energy source; obtaining solids from the acidic cellulose solution; and drying the solids to obtain cellulose nanocrystals.

The cellulose solution comprises cellulose, water, and an acid, such as sulfuric acid or hydrochloric acid. Optionally, the cellulose solution may also contain one or more additives such as surfactants and/or stabilizers. Though not to be bound by theory, surfactants and/or stabilizers may enhance cellulose dispersion in solution or improve the quality of the CNC produced by the method. In embodiments wherein the cellulose is plant-based, such plant-based material typically benefits from bleaching to increase cellulose purity, improve hydrolysis efficiency, and/or increase the quality and/or uniformity of CNCs.

There are several types of commercially available plant-based cellulose including wood-based cellulose such as pulp and microcrystalline cellulose (MCC) which are derived from pine, spruce, and oak. Other suitable cellulose sources include cotton, bamboo, hemp, sugarcane bagasse, date palm frond, and other agricultural residues. Some well-known companies providing such commercially available cellulose are Dupont, DFE Pharma, FMC Corporation, and CelluForce.

The cellulose solution may include shredded and/or ground cellulose. The shredded and/or ground cellulose may be subjected to one or more alkali or acidic treatments, e.g., sodium hydroxide, distilled water, sodium chlorite, acetic acids, other organic acids, sulfuric acid, or two or more thereof, before or during the adding of the weak organic acid and the Lewis acid to the cellulose solution.

The weight ratio of cellulose to weak organic acid may vary. In some embodiments, the ratio of cellulose (e.g., plant-based cellulose) to acid (e.g., formic acid) is 1:5 to 1:15 (wt:wt), meaning for every gram of cellulose, 5-15 g of weak organic acid are used. This ratio may depend on the type of cellulose and the desired level of hydrolysis. In some embodiments, the ratio of weak organic acid (e.g., formic acid) to Lewis base (e.g., AlCl₃) is 100:1 to 300:1 (wt:wt), meaning that the amount of Lewis base typically remains low compared to weak organic acid. This ratio is beneficial as the Lewis base serves as a catalyst to enhance the breakdown of amorphous cellulose regions to accelerate the hydrolysis reaction. In some embodiments, the ratio of cellulose to water is 1:5 to 1:10 (wt:wt), which can also vary depending on the concentration of the cellulose and acid used. Water may help control the viscosity and improve uniformity of mixing.

The term “Lewis acid” refers to a chemical compound containing an empty orbital which is capable of accepting an electron pair from a Lewis base and forming a Lewis adduct. The Lewis acid may include an aluminum-based compound, boron-based compound, or combinations of both aluminum-based compounds and boron-based compounds. A non-limiting list of Lewis acids include: AlX₃, AlX₂R, AlXR₂, AlR₃, BX₃, BX₂R, BXR₂, BR₃, wherein each X comprises a halogen independently selected from the group consisting of chlorine, fluorine, or bromine, and each R comprises hydrocarbyl or heterohydrocarbyl independently selected from (C₁-C₁₀)alkyl, (C₆-C₁₂)aryl, —O(C₁-C₁₀)alkyl, or —O(C₆-C₁₂)aryl. In some embodiments, the Lewis acid is AlCl₃, BCl₃, or combinations of AlCl₃ and BCl₃. In one or more embodiments, the Lewis acid is AlCl₃.

The weak organic acid comprises an organic acid having a pKa of 3.0 to 6.0. The term “organic acid” refers to organic compounds that possess acidic properties. A common organic acid is carboxylic acid. Generally, weak organic acids do not fully dissociate in water. The term “weak organic acids” does not include acids such as mineral acid, like HCl, H₂SO₄, HNO₃, H₃PO₄.

A non-limiting list of weak organic acids includes acetic acid, derivatives of acetic acid (such as benzoic acid and RCOOH, wherein R is a hydrocarbyl), formic acid, oxalic acid, benzoic acid. In one or more embodiments, the weak organic acid comprises formic acid.

Embodiments of this disclosure utilize weak organic carboxylic acids. Surprisingly the weak organic acids may be 90% recovered by simple distillation, making the synthesis of the CNCs more sustainable than having to continually add new acid to produce CNCs. However, formic acid (pKa=3.75) is a relatively weak acid that does not fully dissociate in the solution when compared to sulfuric acid and other mineral acids. Due to the weak disassociation of organic acids, the theoretical yield is decreased when compared to strong mineral acid (also called inorganic acids).

Thus, to increase yield, the addition of a Lewis acid along with the weak organic carboxylic acid creates more acidic conditions in combination with the weak organic acid.

Generally, the extraction of the CNCs typically occurs via inorganic acid hydrolysis. Using inorganic acids, such as sulfuric acid, to extract CNCs produces negatively charged sulfate groups on the surface of CNCs, which reduce thermal stability properties. The CNCs produced from the methods of this disclosure are substantially free of sulfate ions. The phrase “substantially free of”, regarding the amount of sulfate ions, refers to an amount of less than 10 parts per million. While sulfate ions, and more specifically sulfuric acid, are not intentionally added to the reaction, it should be understood that sulfate ions may remain in glassware, barrels, or other containers, and should be considered as impurities within the final compound.

The temperature and reaction time of the hydrolyzing may be varied. In some embodiments, the hydrolyzing temperature may be about 25° C. to about 60° C., such as about 25° C. to about 30° C. or about 40° C. to about 60° C. In some embodiments, the hydrolyzing reaction time may be about 20 minutes to 30 minutes, 30 minutes to about 90 minutes, or about 10 hours to about 24 hours. The person of ordinary skill in the art having the benefit of the present disclosure may select particular hydrolysis reaction times and temperatures in view of the acid concentration of the solution, solution agitation, cellulose source, and/or techniques of reaction quenching and neutralization. Generally, although lower reaction temperatures and longer reaction times might lead to increased costs and operational inefficiency, such conditions may minimize overhydrolysis or breakdown of amorphous and crystalline regions of the cellulose, relative to higher temperatures and shorter reaction times. Overhydrolysis and/or amorphous/crystalline region breakdown may generate smaller CNCs having lower crystallinity or thermal instability.

The source of the microwave energy applied to the hydrolysis reaction may be derived from a multi-mode or a single mode microwave cavity. The microwave energy source may be a microwave oven, a microwave reactor, or may be coupled with an ultrasonication application. The microwave energy source may be the Multiwave 5000®, the Monowave®, or the Monowave 400 R® from www/anton-paar.com. Other microwave energy sources may be obtained from CEM.com.

In some embodiments, the hydrolysis product may be subjected to one or more techniques to remove unreacted cellulose and amorphous regions. For example, amorphous regions and unreacted cellulose may be subjected to chemical removal methods, such as strong acid treatment, though the acid concentration and reaction time should be borne in mind to avoid over-hydrolysis and degradation; and/or physical removal methods, such as centrifugation of the suspension (e.g., at 10,000-15,000 rpm for 10-30 minutes), filtration (e.g., using fine-pore filters or sieves, optionally assisted with vacuum); or sedimentation (e.g., by leaving the hydrolyzed mixture undisturbed for several hours, allowing heavier fibers to separate to the bottom while CNCs remain in suspension).

When obtaining the solids, the methods may further include subjecting the acidic cellulose solution to centrifugation. The acidic solution is placed in a centrifuge, and due to the centripetal force, the solids may be separated from the surrounding solution. As a result of the centrifuge, the solids are collected at a bottom of a container. The solids may then be subjected to microwave-assisted ultrasonication.

Though not to be bound by theory, microwave-assisted ultrasonication may help in processing cellulose nanocrystals after hydrolysis by making drying and handling easier. Microwave heating may provide rapid and uniform heating of the suspension, thus accelerating water evaporation. Ultrasonication may help in generating mechanical forces that break down agglomerates or clusters of CNCs into individual nanocrystals.

The microwave assisted ultrasonication may occur for about 10 to about 60 minutes. In a non-limiting range of time the microwave assisted ultrasonication may occur includes: about 10 minutes to about 50 minutes (min); about 10 min to about 40 min; about 10 min to about 30 min; about 15 min to about 50 min; about 15 min to about 40 min; about 15 min to about 30 min; or about 15 min to about 25 min. Regarding the term “about”, as it is used in relation to a time of minutes, refer to ±1 minute.

In the methods of this disclosure, the solids may be dried by spray drying and the spray-drying temperature is from about 50° C. to about 200° C. The solids may be dried under reduced pressure conditions, or the solids may be dried in an oven. The spray drying temperature and/or the oven temperature may range from about 50° C. to about 200° C.; about 100° C. to about 200° C.; about 120° C. to about 180° C.; about 120° C. to about 170° C.; about 120° C. to about 160° C.; about 120° C. to about 150° C.; about 130° C. to about 200° C.; about 130° C. to about 190° C.; about 130° C. to about 180° C.; about 130° C. to about 170° C.; about 130° C. to about 160° C.; about 130° C. to about 150° C.; about 140° C. to about 200° C.; about 140° C. to about 190° C.; about 140° C. to about 180° C.; about 140° C. to about 170° C.; about 140° C. to about 160° C.; about 140° C. to about 150° C.; or about 140° C. to about 200° C.

Embodiments of this disclosure include composition including cellulose nanocrystals, e.g., cellulose nanocrystals that are substantially free of sulfate ions. Cellulose nanocrystals may have a thermal stability of about 200° C. to about 300° C. The thermal stability value for a given sample of cellulose nanocrystals may depend on the cellulose source, surface chemistry of the cellulose, and/or the method of preparation, among other properties. Sulfated CNCs may have a slightly lower thermal stability (200° C.-220° C.) compared to non-sulfated CNCs (230° C.-250° C.).

Embodiments of this disclosure include methods for drilling subterranean formations. The methods include adding cellulose nanocrystals produced from the green synthesis method of this disclosure to a water-based drilling fluid to create an enhanced water-based drilling fluid. The enhanced water-based drilling fluid is introduced to a subterranean formation. The enhanced water-based drilling fluid may be circulated within the subterranean formation.

The methods may further include mixing at least one or more additives selected from the group consisting of weighting agents, fluid loss control agents, lost circulation control agents, viscosifiers, dispersants, pH buffers, electrolytes, glycols, glycerols, dispersion aids, corrosion inhibitors, defoamers, deformers, starches, xanthan gum polymers, surfactants, or combinations thereof with the aqueous phase, the clay-based component, and the polyglycerol-fatty acid complex to form the drilling fluid. The additives may be in accordance with any of the embodiments previously described.

Embodiments of the disclosure may also relate to methods for using the enhanced drilling fluid. The enhanced drilling fluid may be in accordance with any of the embodiments previously described. In some embodiments, the enhanced drilling fluid may be introduced into a subterranean formation. Introducing may involve injecting the enhanced drilling fluid into the subterranean formation, which in some embodiments may be a well. The enhanced drilling fluid may be circulated within the subterranean formation. In some embodiments, a mud pump may be used to inject the enhanced drilling fluid into the subterranean formation.

In some specific embodiments the disclosure relates to methods of using the enhanced drilling fluid for oil and gas drilling. The methods may include pumping the enhanced drilling fluid through a drill string to a drill bit and recirculating the enhanced drilling fluid. Recirculating the enhanced drilling fluid may allow the enhanced drilling fluid to lubricate the drill bit. CNCs have excellent thermal properties that may improve heat dissipation from the drill bit, reducing the risk of overheating. CNC materials also influence the rheology of drilling fluids, which may help in improving the suspension and flow properties, and may aid in better cuttings transport and fluid stability. Moreover, considering the biological origin of CNCs, biodegradability and renewability provide an environmentally friendly alternative to synthetic additives.

The use of CNCs in drilling fluids may result in energy savings of about 5-15%, mainly through reduced friction, better heat dissipation, and improved efficiency. These savings could lead to lower operational costs over time. While CNCs may have higher production costs (~$1000-$3000 per ton) than traditional additives, such as bentonite polymers (~$500-$1500 per ton), CNCs may be locally sourced and the potential energy savings discussed above may provide lower overall costs. Local sourcing, e.g., from date palm (Phoenix dactylifera L.) frond waste for oil and gas drilling operations in Saudi Arabia, may further transform local biological wastes into industrially valued products that are renewable and environmentally friendly.

### EXAMPLES

### Example 1: Green Synthesis of CNC Using Microwaves as an Energy Source

The cellulose solution of water and plant-based material was hydrolyzed under microwave conditions to further contribute towards the greener synthesis of CNCs. The microwave assisted hydrolysis provided a shorter reaction time, approximately 20 minutes, unlike the conventional conductive heating hydrolysis, which may require reactions times of greater than 120 minutes. Using the microwaves as an energy source also consumes 47% less energy to achieve CNCs, and enhances the degradational process of the amorphous regions by accelerating the diffusion rate of Al³⁺ and Cl⁻ ions in the hydrogen bonding network of the formic acid solution.

A solution of AlCl₃ and formic acid hydrolysis was added to a cellulose mixture of water and plant-based material. The plant-based material was obtained from local date palm trees and agricultural residues. In a three-pronged round bottom flask, a temperature probe monitored the reaction temperature was inserted into the cellulose mixture, while the acid solution of AlCl₃ and formic acid were added dropwise into the cellulose mixture. The reaction was heated and stirred under reflux conditions.

The round bottom flask was fitted inside a microwave equipped with a colored image recording system to deliver real time display of the hydrolysis reaction process. The reaction process was carried out for 20 mins under 125° C. to avoid the destruction of the nanocellulose structure when left for longer reaction time and higher temperature. Then, the reaction temperature was decreased to 25° C. to allow the mixture to cool down for 10 mins. The mixture was subjected to centrifugation, micro-wave assisted ultrasonication for 20 mins, and spray-dried at 170° C. to extract the thermally stable CNCs drilling fluid additives.

In conclusion, the cellulose solution of water and plant-based material was hydrolyzed under microwave conditions to further contribute towards the greener synthesis of CNCs. The microwave assisted hydrolysis provided a shorter reaction time, approximately 20 minutes, unlike the conventional conductive heating hydrolysis, which may require reaction times of greater than 120 minutes. Using microwaves as an energy source also consumed 47% less energy to achieve CNCs, and enhanced the degradational process of the amorphous regions by accelerating the diffusion rate of Al³⁺ and Cl⁻ ions in the hydrogen bonding network of the formic acid solution.

### Example 2: Production of CNCs from Cellulose Sourced from Date Palm Frond Waste

Materials. Date palm (Phoenix dactylifera L.) frond waste was collected from local resources in Saudi Arabia. Sulfuric acid (H₂SO₄, 98%) and acetic acid glacial (CH₃COOH, 100%) were purchased from Fisher Chemicals™. Sigma-Aldrich provided sodium hydroxide (NaOH) and sodium chlorite (NaClO₂). 10,000 MWCO SnakeSkin® dialysis tube was obtained from Thermo Scientific™.

### Methods.

Preparation of raw date palm fiber. 100 grams of frond biomass waste was cut into small pieces (2-3 mm), washed with DI water, and allowed to dry under sunlight for 18 h. Following that, the material was finely ground using a stainless-steel grinder for 5 mins and sifted through a 120-mesh sieve. The obtained powder was then soaked in DI water for 24 h to remove dirt, vacuum-filtered to remove excess water, and placed in an air-circulated oven at 100° C. for 6 h to remove moisture.

Isolation of cellulose from date palm biomass waste. A chemical pretreatment method for the extraction of cellulose from the raw fibers was followed. Raw fibers of fronds from date palms were treated with 7% w/v NaOH under reflux condensation at 90° C. with constant stirring for 4 h for the purpose of delignification. The delignified cellulose residue was then vacuum-filtered and rinsed several times with DI water until the pH of the filtrate reached a neutral value of 6.5-7. The delignified cellulose residue was then oven-dried at 110° C. for 6 h until it showed constant weight readings. Then, bleaching was performed on the material following alkali treatment by treating the material with an aqueous solution of 5% NaClO₂. The pH was continuously adjusted to 4.5 using acetic acid, and the solution was stirred for 3 h at a fixed temperature range of 75-80° C. The final product was vacuum-filtered with DI water several times until a neutral pH was achieved. The bleached sample was then placed in an air-circulating oven at 110° C. for 6 h until reaching a stable weight.

Isolation of cellulose nanocrystals. Cellulose nanocrystals (CNCs) were extracted with sulfuric acid hydrolysis. In brief, an amount of 100 grams of isolated cellulose fibers were immersed in a 30% (w/w) H₂SO₄ solution with a ratio of cellulose-to-dilute H₂SO₄ of 1:20 g/mL at 45° C. for 45 mins under vigorous and constant mechanical stirring. The hydrolysis reaction was quenched by the addition of 10-fold chilled DI water to the reaction mixture. The resulting colloidal suspension from the acid hydrolysis step is centrifuged for 30 mins at 6000 rpm to remove residual sulfuric acid followed by excessive washing with DI water until neutral pH is maintained. Then, the neutralized suspension of CNCs was dialyzed against DI water for 5 continuous days to eliminate the sulfate ions with a water change of five times at a rate of once per day. The resulting suspension was then ultrasonicated for 60 mins to break apart and disperse the CNC bundles. CNC suspension was then placed in a −80° C. freezer followed by lyophilization using a Labconoco 12 L freeze-drier at −50° C. and a vacuum of 0.11 mBar for 2 days. The freeze-dried CNC powder was kept in a sealed bag for further characterization.

### Characterization of Cellulose Nanocrystals.

Zeta potential. The surface charges of obtained CNCs were estimated through zeta (C) potential analysis of the CNC dispersion at 25° C. using an Anton Paar Litesizer™ 500 instrument, which measures the electrophoretic mobility of the particles and converts it to zeta potential following Smoluchowski theory. A very dilute dispersion was made by taking (0.01 wt %) of the samples in deionized water and sonicating for 3 minutes at 25° C. to allow for better dispersion of the particles in the aqueous solution. The measurement was acquired at a laser wavelength of 658 nm.

Thermogravimetric analysis (TGA). The thermal degradation patterns of samples of cellulose and CNC produced therefrom were assessed using TGA by measuring the amount of change in the sample weight as a function of temperature. TGA curves of the extracted cellulose and resulting CNC samples, with a weight of 5 mg, were generated in a TG 209 F1 Iris analyzer (Netzsch). The two samples were heated from 50° C. to 800° C. at a constant heating rate of 10° C./min under a nitrogen environment with a gas flow of 60 mL/min.

X-ray diffraction (XRD). The pattern and crystallinity degree of cellulose and the synthesized nanocellulose crystals were evaluated at ambient temperature using Bruker D2 Phaser 2^{nd} Gen. The experiment was carried out with Cu—K radiation operating at voltage of 40 kV, an electrical current of 30 mA, a receiving slit of 0.15 mm, covering the 2-theta range from 10°-80°, with a scanning speed of 2°/min. The crystallinity index of the samples was calculated using the Segal method in Equation 1:

$$CrI ( \% ) = \frac{{I}_{002} - {I}_{a m}}{{I}_{002}} \times 100 \qquad [ Equation 1 ]$$

where I₀₀₂ denotes the crystallinity region and Iₐₘ denotes the area of amorphous region of the samples.

Differential scanning calorimetry (DSC). The nature of the prepared samples in relation to their thermal transitions was ascertained using the thermoanalytical technique of DSC, which describes the sample's thermal behavior in terms of endothermic or exothermic manner. DSC runs were performed in a TA Instruments Discovery DSC 250 using samples of 5 mg in sealed aluminium pans. All the experiments were performed under a dry N₂ atmosphere (50 mL/min) with a heating rate of 10° C./min from 30° C. to 350° C. For the DSC runs, scans with upward motions indicate exothermic phase changes whereas scans with downward motions indicate endothermic phase changes in the scope of the current study.

Fourier-transform infrared spectroscopy (FTIR). The FTIR spectra were recorded to assess the changes in the functional groups induced by different treatments and confirm the success of the hydrolysis process. Attenuated total reflection Fourier transform (ATR-FTIR) equipped with a diamond probe by Nicolet™ iS™ FTIR Spectrometer (Thermo Scientific, USA) was used to record the FTIR spectra. The FTIR spectral analysis was performed with an average of 16 scans and a spectral resolution of 6 cm⁻¹ within a range of 525-4000 cm⁻¹.

Scanning electron microscopy (SEM). The surface morphology of the synthesized cellulose nanocrystals was obtained using a field emission scanning electron microscope (FE-SEM, Carl Zeiss Merlin). The accelerating voltage used for the samples imaging was 5 kV with a probe current of 30 pA and a working distance of 11 mm. All samples were coated with 3 nm thick iridium coating to avoid electrostatic charge effect upon imaging.

### Results and Discussion.

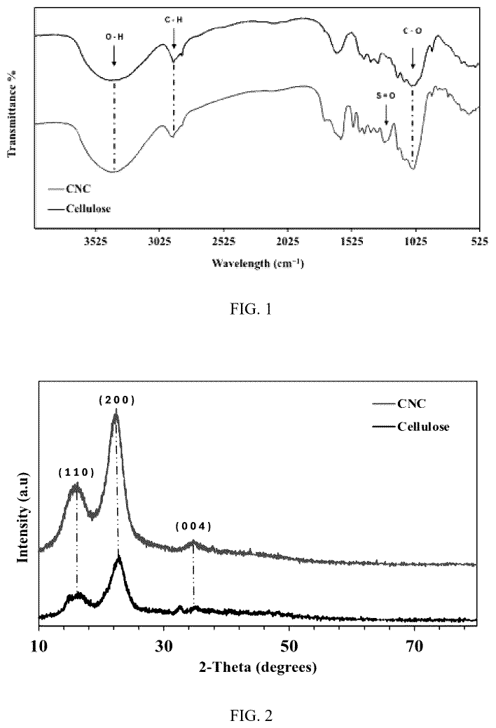

FTIR-ATR analysis. FTIR spectra of cellulose and its CNC are presented in FIG. 1. Both cellulose and CNC show similar FTIR spectra, indicating that CNC was successfully extracted through the acid hydrolysis treatment without resulting in material degradation or secondary products formation. The intensity of peaks may vary between cellulose and CNC, reflecting the difference in structure and surface chemistry between the two materials. A broad spectrum band of cellulose and CNC at approximately 3370 cm⁻¹ corresponds to the O—H stretching vibration of the hydrogen bonded groups, attributed to the hydrohphilic nature of the samples. Furthermore, the stretching of the C—H bonds corresponds to the appearance of the strong bands at around 2800-2900 cm⁻¹ while the band at 1033 cm⁻¹ corresponds to the antisymmetric stretching vibration of the C—O group. Nevertheless, the relatively narrow and short band appearing at approximately 1270 cm⁻¹ in the CNC spectrum indicates the presence of a sulfated group attributed to the cellulose sulfonation process following the sulfuric acid hydrolysis treatment.

XRD analysis. The acid hydrolysis treatment of cellulose enhances the crystallinity of the fibers by eliminating the amorphous regions of cellulose while keeping the crystalline regions intact. Herein, XRD analysis was employed to observe differences in crystallinity pattern between cellulose and CNC. Further, the degree of crystallinity acts as an indirect parameter influencing the thermal property of the material. The XRD graph in FIG. 2 shows three well-defined peaks at approximately 2θ=16°, 22°, and 35° corresponding to (1 1 0), (2 0 0), and (0 0 4) planes, respectively, which are typical characteristics of cellulose type I polymorph. The crystallinity index was obtained by Equation 1. The crystallinity of cellulose extracted from date palm frond was 61.8% while the crystallinity of CNC was 74.2%. The higher crystallinity index of CNC is attributed to the increased rigidity of the produced crystals and due to the acid hydrolysis treatment that hydrolyzed the amorphous component of cellulose, leaving the crystalline region intact. This is expected to result in increased tensile strength of CNC, which may help the transportation efficiency of drilling cuttings and other debris from the wellbore to the surface with reduced chances of failure. Additionally, the higher degree of crystallinity exhibited by CNCs may provide them with greater structural integrity that makes them more resistant to thermal decomposition, and hence more thermally stable than cellulose.

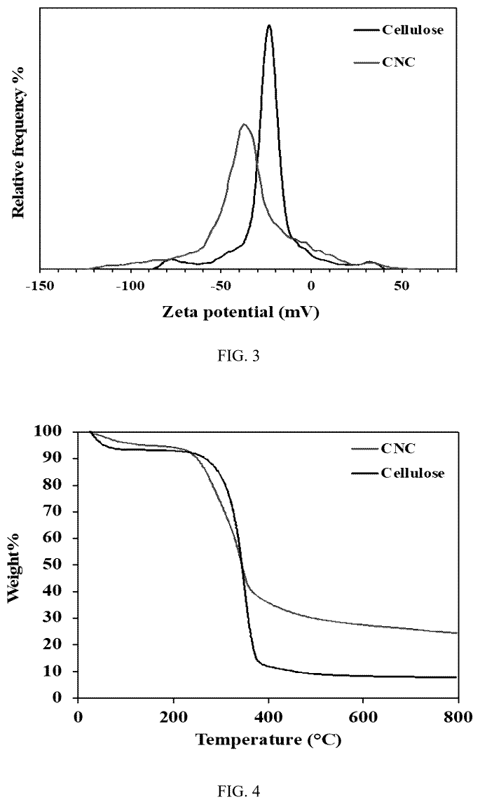

Zeta potential. In drilling applications, drilling fluid additives need to be properly dispersed to maintain consistent properties such as viscosity, density, and lubrication. If the additives exhibit rapid aggregation, this can lead to uneven fluid properties and compromised performance during drilling operations, resulting in producing zone damage and consequently impeding the drilling efficiency. Zeta potential measurements as shown in FIG. 3 were performed to study the stability of CNC drilling fluid colloids. Stable suspensions of CNC were expected to have a zeta potential value of less than −15 mV or greater than +15 mV. FIG. 3 reports a mean zeta potential value of −34 mV for the CNC suspension in water, which indicates good physical stability due to the strong electrostatic repulsive forces between the nanocrystals. When compared to a cellulose suspension, which reported a mean zeta potential value of −24 mV, the suspension stability has significantly increased. Though not to be bound by theory, the attachment of the SO₄²⁻ ions of the sulfuric acid hydrolysis treatment on the surface of the CNC, may result in a greater negative surface potential.

TGA analysis. TGA curves shown in FIG. 4 depict the thermal decomposition of the extracted cellulose and its CNC, providing an important indication of their thermal stability behaviors for drilling fluid applications. Both cellulose and CNC illustrated an initial weight loss in the temperature range between 70-140° C. that is likely attributed to moisture loss due to evaporation of water or potentially other chemically unstable compounds. At temperatures above 200° C., CNC showed lower decomposition temperature relative to cellulose. This may be attributed to the sulfate groups attachment following the sulfuric acid hydrolysis treatment, which reacted with the released water to produce sulfuric acid and hence catalyzed the degradation process. CNC only shows slight reduction in thermal stability in the relevant temperatures range. Furthermore, CNC showed more residue formation and less total weight loss when compared to cellulose at temperatures above about 400° C. The final weight percentages reported for cellulose and CNC at the final temperature of 800° C. were 24.3% and 7.9%, respectively. CNC has a higher degree of crystallinity compared to cellulose. The ordered arrangement of cellulose chains in CNCs makes them more resistant to thermal degradation, leading to less weight loss compared to the less organized structure of bulk cellulose. This interpretation is in alignment with the XRD analysis presented in FIG. 2. Also, CNC typically has a considerably higher surface area than cellulose. This higher surface area can lead to increased interactions with reactive species during thermal degradation, resulting in more residue formation.

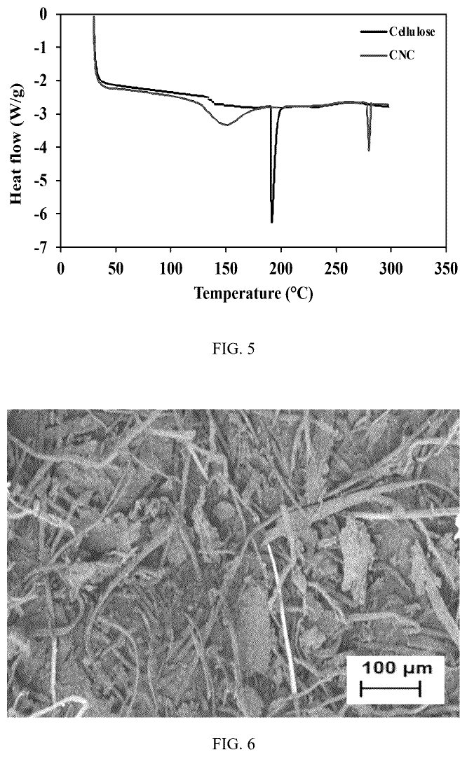

DSC analysis. DSC thermograms of the extracted cellulose and its CNC is presented in FIG. 5. The broad first endothermic peak of CNC, occurring in the range 120° C.-180° C., indicates loss of absorbed water from the matrix of the material. This is in alignment with the high surface area to volume ratio and the abundance of accessible hydroxyl groups in cellulose nanocrystals, which are believed to allow them to absorb large amounts of water. The second sharp and narrow endothermic peak of CNC, occurring at approximately 280° C., is a characteristic of melting or fusion of CNC crystallites in the cellulose thermogram, revealing the process of thermal decomposition. Similar endothermic peak corresponding to a thermal decomposition process also occurs in cellulose around 190° C. When comparing both decomposition peaks for CNC and cellulose, CNC exhibits peaks with higher temperature values, indicating that the thermal stability of the material has been improved owing to the sulfuric acid hydrolysis treatment. As a result, CNC provides a promising solution to overcoming the challenge of polymer degradation in water-based drilling fluids under high temperature conditions.

SEM analysis. The SEM micrograph shown in FIG. 6 represents the surface morphological structure of CNC at a spatial resolution of 100 micrometers. Cellulose has been broken into tiny rod-like shape particles following the acid hydrolysis treatment due to the ordered arrangement of cellulose chains. The resulting particle shapes are typical of the acid hydrolysis treatment. The size of the particles ranged in length and diameter between 150-300 nm and 10-20 nm, respectively. Moreover, a relative degree of agglomeration within the obtained nanocellulose was revealed by the acquired SEM image. Nanocellulose is composed of cellulose nanofibers that have numerous hydroxyl groups capable of forming hydrogen bonds with each other. When these bonds form, they create attractive forces between the nanocellulose particles that exhibit relatively small sizes and high surface areas, leading to their agglomeration or clumping together.

Claims bank for foreign filing—TO-BE ADDED AFTER APPROVAL OF THE CLAIMS

Embodiments disclosed herein include:

Embodiment A: A method of producing cellulose nanocrystals (CNCs) comprising: combining a weak organic acid, a Lewis acid, and a cellulose, and water to form an acidic cellulose solution; hydrolyzing the acidic cellulose solution at a temperature from about 25° C. to about 140° C. or a reaction time from about 20 minutes to about 24 hours via a microwave energy source to create CNCs; separating the CNCs from the remaining acidic cellulose solution; and drying the CNCs.

Embodiment B: A method comprising: adding cellulose nanocrystals produced from claim 1 to a water-based drilling fluid to create an enhanced water-based drilling fluid; and introducing the enhanced water-based drilling fluid to a subterranean formation. Each of embodiments A and B may have one or more of the following additional elements in any combination:

Element 1: wherein the Lewis acid comprises an aluminum-based compound, a boron-based compound, or combinations of aluminum-based compounds and boron-based compounds.

Element 2: wherein the Lewis acid comprises AlCl3, BCl3, or a combination of AlCl3 and BCl3.

Element 3: wherein the Lewis acid comprises AlCl3.

Element 4: wherein the weak organic acid is an organic acid having a pKa of 3.0 to 6.0.

Element 5: wherein the weak organic acid is formic acid.

Element 6: wherein the weak organic acid is formic acid and the Lewis acid is AlCl3.

Element 7: wherein the separating CNCs comprises: subjecting the acidic cellulose solution to centrifugation; and applying microwave-assisted ultrasonication.

Element 8: wherein the microwave assisted ultrasonication is for about 10 to about 60 minutes.

Element 9: wherein the drying the CNCs comprises spray-drying at about 120° C. to about 200° C.

Element 10: wherein the drying the CNCs comprises drying under reduced pressure conditions.

Element 11: wherein the drying the CNCs comprises drying in an oven.

Element 12: wherein the cellulose solution comprises plant-based material and water.

Element 13: wherein the CNCs are substantially free of sulfate ions.

Element 14: wherein the CNCs are thermally stable up to a temperature of about 200° C. to about 300° C.

Element 15: further comprising circulating the enhanced water-based drilling fluid within the subterranean formation.

Element 16: wherein the cellulose nanocrystals have a thermal stability of about 200° C. to about 300° C.

By way of non-limiting example, exemplary combinations applicable to A through B include: Element 1 with Element 2; Element 2 with Element 3; Element 3 with Element 4; Element 2 with Element 5; Element 1 with Element 6; Element 7 with Element 8; Element 9 with Element 10; Element 10 with Element 11; Element 10 with Element 12; and Element 10 with Element 13.

### Additional Embodiments

Embodiment 1. A method of producing cellulose nanocrystals (CNCs) comprising: combining a weak organic acid, a Lewis acid, and a cellulose, and water to form an acidic cellulose solution; hydrolyzing the acidic cellulose solution at a temperature from about 25° C. to about 140° C. or a reaction time from about 20 minutes to about 24 hours via a microwave energy source to create CNCs; separating the CNCs from the remaining acidic cellulose solution; and drying the CNCs.

Embodiment 2. The method of embodiment 1, wherein the Lewis acid comprises an aluminum-based compound, a boron-based compound, or combinations of aluminum-based compounds and boron-based compounds.

Embodiment 3. The method of embodiment 1 or 2, wherein the Lewis acid comprises AlCl3, BCl3, or a combination of AlCl3 and BCl3.

Embodiment 4. The method of any one of embodiments 1 to 3, wherein the Lewis acid comprises AlCl3.

Embodiment 5. The method of any one of embodiments 1 to 4, wherein the weak organic acid is an organic acid having a pKa of 3.0 to 6.0.

Embodiment 6. The method of any one of embodiments 1 to 5, wherein the weak organic acid is formic acid.

Embodiment 7. The method of any one of embodiments 1 to 6, wherein the weak organic acid is formic acid and the Lewis acid is AlCl3.

Embodiment 8. The method of any one of embodiments 1 to 7, wherein the separating CNCs comprises: subjecting the acidic cellulose solution to centrifugation; and applying microwave-assisted ultrasonication.

Embodiment 9. The method of embodiment 8, wherein the microwave-assisted ultrasonication is for about 10 to about 60 minutes.

Embodiment 10. The method of any one of embodiments 1 to 9, wherein the drying the CNCs comprises spray-drying at about 120° C. to about 200° C.

Embodiment 11. The method of any one of embodiments 1 to 10, wherein the drying the CNCs comprises drying under reduced pressure conditions.

Embodiment 12. The method of any one of embodiments 1 to 11, wherein the drying the CNCs comprises drying in an oven.

Embodiment 13. The method of any one of embodiments 1 to 12, wherein the cellulose solution comprises plant-based material and water.

Embodiment 14. The method of any one of embodiments 1 to 13, wherein the CNCs are substantially free of sulfate ions.

Embodiment 15. The method of any one of embodiments 1 to 14, wherein the CNCs are thermally stable up to a temperature of about 200° C. to about 300° C.

Embodiment 16. A method comprising: adding cellulose nanocrystals produced from any one of embodiments 1 to 15 to a water-based drilling fluid to create an enhanced water-based drilling fluid; and introducing the enhanced water-based drilling fluid to a subterranean formation.

Embodiment 17. The method of embodiment 16, further comprising circulating the enhanced water-based drilling fluid within the subterranean formation.

Embodiment 18. The method of embodiment 16 or 17, wherein the cellulose nanocrystals have a thermal stability of about 200° C. to about 300° C.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method of producing cellulose nanocrystals (CNCs) comprising:
combining a weak organic acid, a Lewis acid, and a cellulose, and water to form an acidic cellulose solution;
hydrolyzing the acidic cellulose solution at a temperature from about 25° C. to about 140° C. or a reaction time from about 20 minutes to about 24 hours via a microwave energy source to create CNCs;
separating the CNCs from the remaining acidic cellulose solution; and
drying the CNCs.

2. The method of claim 1, wherein the Lewis acid comprises an aluminum-based compound, a boron-based compound, or combinations of aluminum-based compounds and boron-based compounds.

3. The method of claim 1, wherein the Lewis acid comprises AlCl₃, BCl₃, or a combination of AlCl₃ and BCl₃.

4. The method of claim 1, wherein the Lewis acid comprises AlCl₃.

5. The method of claim 1, wherein the weak organic acid is an organic acid having a pKa of 3.0 to 6.0.

6. The method of claim 1, wherein the weak organic acid is formic acid.

7. The method of claim 1, wherein the weak organic acid is formic acid and the Lewis acid is AlCl₃.

8. The method of claim 1, wherein the separating CNCs comprises:
subjecting the acidic cellulose solution to centrifugation; and
applying microwave-assisted ultrasonication.

9. The method of claim 8, wherein the microwave assisted ultrasonication is for about 10 to about 60 minutes.

10. The method of claim 1, wherein the drying the CNCs comprises spray-drying at about 120° C. to about 200° C.

11. The method of claim 1, wherein the drying the CNCs comprises drying under reduced pressure conditions.

12. The method of claim 1, wherein the drying the CNCs comprises drying in an oven.

13. The method of claim 1, wherein the cellulose solution comprises plant-based material and water.

14. The method of claim 1, wherein the CNCs are substantially free of sulfate ions.

15. The method of claim 1, wherein the CNCs are thermally stable up to a temperature of about 200° C. to about 300° C.

16. A method comprising:
adding cellulose nanocrystals produced from claim 1 to a water-based drilling fluid to create an enhanced water-based drilling fluid; and
introducing the enhanced water-based drilling fluid to a subterranean formation.

17. The method of claim 16 further comprising circulating the enhanced water-based drilling fluid within the subterranean formation.

18. The method of claim 16, wherein the cellulose nanocrystals have a thermal stability of about 200° C. to about 300° C.
